(19) United States
(12) Patent Application Publication
(10) Pub. No.: US 2015/0254971 A1
(43) Pub. Date: Sep. 10, 2015

(54) Systems and Methods Of Calibrating Replacement Alarm Control Panels

(71) Applicant: Honeywell International Inc., Morristown, NJ (US)

(72) Inventors: Mark Okeefe, San Diego, CA (US); David Llenaresas, San Diego, CA (US); Kenneth Eskildsen, Great Neck, NY (US); Tom Winkeler, Saint James, NY (US); Yuxia Lu, South Setauket, NY (US); Dave Mole, Medford, NY (US)

(21) Appl. No.: 14/639,372

(22) Filed: Mar. 5, 2015

Related U.S. Application Data
(60) Provisional application No. 61/950,347, filed on Mar. 10, 2014.

(51) Int. Cl. G08B 29/12

(52) U.S. Cl. CPC G08B 29/126

(57) ABSTRACT

An apparatus and method of up-dating an existing alarm monitoring system control panel having installed wire loops, with detectors coupled thereto, and installed end-of-line resistors. Upon removal of the existing control panel, the loops are coupled to an up-graded control panel having an adjustable loop interface. The existing loops can be coupled to the adjustable loop interface. The interface automatically determines operating loop voltages in view of existing end-of-line resistors. Detectors on the loops can be read without any changes needed to end-of-line resistor values. Determined operating loop voltages can be digitized and stored in the up-graded control panel for subsequent use in monitoring loop operating characteristics.

### CROSS-REFERENCE TO RELATED APPLICATION

This application claims the benefit of the filing date of U.S. Provisional Application Ser. No. 61/950,347 filed Mar. 10, 2014, entitled, “Systems and Methods for Calibrating Alarm Panels and Determining End of Line”. The '347 application is hereby incorporated herein by reference.

### FIELD

The application pertains to replacement, multi-mode alarm system control units. More particularly, the applications pertains to such control units which provide wireless communications with ambient condition detectors, and, continuing communications with previously installed detectors which communicate via a wired medium.

### BACKGROUND

Recently, there has been significant interest and demand for wireless alarm systems. Accordingly, dealers, technicians and installers of alarm systems have been attempting to modify traditional hardwired alarm panels for purposes of adapting and incorporating them into a wireless alarm system. Such traditional hard wired systems typically have resistors on the wire runs throughout the building or structure in which they are installed. These resistors can be located at a window, in the building frame or within the walls.

In order to upgrade or replace an existing alarm panel that has traditional hardwired loops or zones, the end of line resistors of the wire runs have needed to be removed and updated resistors have been needed to be incorporated consistent with the new system. Many times, this involves digging into a wall or window frame, which can cause significant damage to the building structure and take up valuable install time. This in turn can lead to additional labor time and increase costs.

FIG. 1 illustrates a prior art monitoring system having a plurality of wired loops to which various types of detectors can be coupled. Each of the loops would usually have an end of line resistor.

Wired systems, such as system 10 in FIG. 1, at installation did not provide wireless communications with installed detectors. As illustrated in FIG. 1, in system 10, a control unit, or panel 12 is coupled via a zone interface to a plurality 14 of wire loops each of which terminates in an end-of-line resistor, such as resistors 16. Each of the wire loops supports a plurality of detectors, such as smoke, gas or thermal detectors. A displaced monitoring station M can communicate with panel 12 as would be understood by those of skill in the art. Any attempt at upgrading panel 12 has required addressing the end-of-line resistor problem.

### BRIEF DESCRIPTION OF THE DRAWINGS

FIG. 1 illustrates a block diagram of a prior art system; and

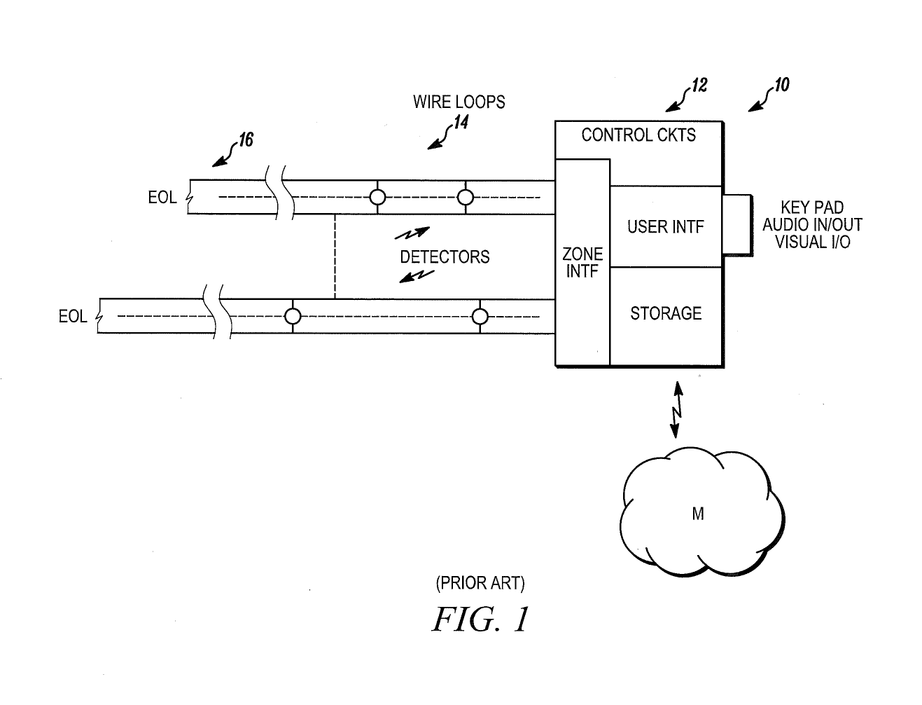

FIG. 2 is a block diagram of a monitoring system in accordance herewith.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

Embodiments presented herein provide systems and methods for calibration of an alarm panel that can allow a technician to automatically calibrate different zones or locations within a building structure. Embodiments further provide for determining and accommodating the existing end-of-Line (“EOL”) resistances present in any hardwired zones installed by the original equipment manufacturers' product. A detected zone voltage is dependent on the value of an EOL resistor.

In operation, embodiments disclosed herein can provide a control panel, or converter module having a reference array. Prior to calibration, valid zones of the hardwired system can be placed into a restored loop state. When a calibration command is initiated, this array can be cleared and voltages sensed at each zone can be digitized and stored in the reference array.

The voltage on each zone within the system can be read at a predetermined or preset time interval, such as for example every 0.1 seconds, and compared against its earlier value in the reference array. Where the two values differ by a predetermined threshold, for instance 0.5 volts, the zone can be considered faulted and can be reported as such.

According to such embodiments, a technician can use any resistance on the wire run from about 2 k to 10 k which covers most conductance values. Activating the process, for example through the new panel's keypad, or, by pressing a calibration button, enables an installer to quickly and easily install the upgraded, wireless system while being able to continue to use the previously installed wired loops detectors, and most importantly, existing end-of-line resistors.

Accordingly, in accordance with embodiments hereof a subsequent alarm control unit, or panel, can be installed to replace an earlier, installed, alarm panel without requiring rewiring or replacing EOL resistors that may be located at other areas within a building. For example, an installer can go to the site of an alarm system previous installed by another vendor and disconnect the hardwired zones from that panel. Then in one embodiment, an interface module, or an updated, replacement panel can be installed and used to reconfigure/calibrate the zones so that they can be detected by the new alarm system and control panel which also can support wireless devices and communications. As a result of this process, the system can then automatically adjust itself to the end of line (EOL) resistor values of the previous installation.

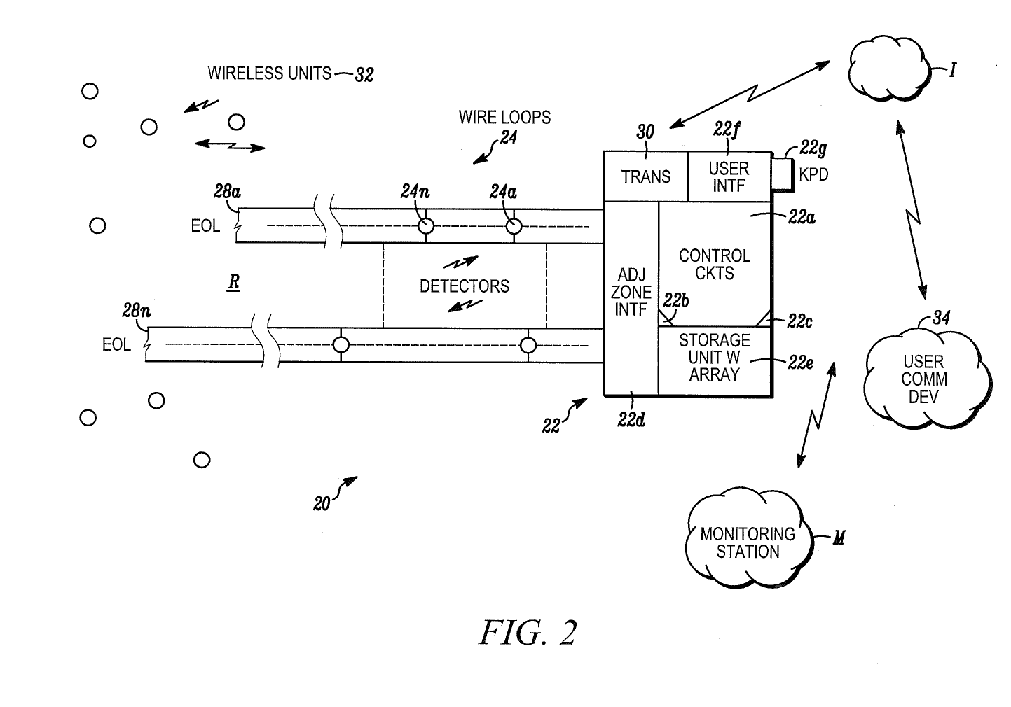

FIG. 2 illustrates an embodiment 20 in accordance with the above. An updated control panel 22 has been coupled to a previously installed plurality of wired zones 24. Those of skill in the art will understood that the zones 24 would each include a wire loop to which is coupled a plurality of detectors or devices, such as 24a, 24b . . . 24n. Additionally, each of the members of the plurality of loops 24 can be expected to include an end of line resistor such as 28a, 28b . . . 28n.

The benefit of the replacement panel 22 is that it can automatically adjust to the existing, installed wire loops and associated end of line resistors. Further, as discussed below, the panel 22 can provide expanded services and capabilities.

The control unit, or panel, 22 includes control circuits 22a which can be implemented at least in part by a programmed processor 22b and executable control software 22c. An adjustable zone interface 22d is coupled to previously installed loops 24.

The interface 22d can adjust, in accordance with existing end-of-line resistance values to communicate with existing devices, such as 24i. No changes are needed in the resistor values of the loops.

The interface 22d can in one embodiment carry out the above described process to read and digitize the voltages from each of the zones, which depend on the value of the end-of-line resistors, such as 28a, 28b . . . 28n. The respective values can be stored in a local storage unit 22e as an array. Newly read resistor values can be compared to earlier values in that array. If the two values, for a given zone differ by a predetermined amount, for example by about one-half a volt, that zone can be considered to be exhibiting a faulted which can then be reported.

The panel 22 can also include a user interface 22f and a display or graphical user interface 22g on which fault information can be presented to an installer. Finally, wireless transceivers 30 coupled to the control circuits 22c can provide wireless communications with a plurality of wireless devices, or detectors 32 which can be installed in the region R being monitored.

Control panel 22 can also communicate wirelessly via transceivers 30, and via a computer network such as the interface I, with one or both of a monitoring station M or a user communication device 34, such as a wireless phone, pad computer or laptop.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. A monitoring system comprising:
a multi-mode wired and wireless control unit wherein the unit includes circuitry to determine end of line resistance values of respective wire loops which are coupled to the control unit and to ambient condition detectors; and
the control unit includes circuitry for storage of the determined loop resistance values and where the control unit has at least one input-output port for communicating with the wire loops.

2. A system as in claim 1 wherein the control unit, includes adjustment circuits, coupled to the port and, responsive to determined end of line resistance values, to configure the unit consistent with the determined resistance values.

3. A system as in claim 2 where the control unit includes circuits to determine loop resistance values by measuring, for each loop, at least one loop voltage value when the respective loop is in a predetermined state.

4. A system as in claim 3 where the measured voltage values are stored in control unit storage circuitry.

5. A system as in claim 4 where the previously measured, stored voltage values are compared to current loop voltage values.

6. A system as in claim 5 where the control unit, responsive to results of the comparison, generates a trouble indictor when a current voltage value falls outside of a predetermined range indicative of acceptable operation.

7. A system as in claim 5 which includes a removable module, wherein at least some of the circuitry to determine voltage values is located in the module such that the control unit, via the module, can interact with a least one of, the wired loops, the wired loops and wireless devices, or wireless devices.

8. A system as in claim 1 wherein the control unit can be calibrated by:
providing at least one adjustable interface for the zones;
placing all valid zones into a selected loop state;
clearing selected portions of the storage circuitry;
determining a digitized value of voltage of each zone when in the selected loop state;
storing the digitized values in the cleared portion of the storage circuitry;
adjusting the interface, responsive to the digitized values, so as to communicate with any detectors coupled to the respective zone.

9. A system as in claim 8 wherein current zone voltages are read at least intermittently, and compared to stored digitized values.

10. A system as in claim 9 wherein if the current zone voltage differs from a respective stored value by a predetermined amount, a fault indictor is generated.

11. A method of calibrating an alarm system comprising:
providing a control unit having a reference array;
detecting sensors of a hardwired alarm system in a plurality of zones;
placing the sensors in a selected loop state;
initiating a selected command to the system;
clearing the reference array;
digitizing an output voltage each of the zones and storing the voltage of each zone in the reference array;
detecting the voltage of the zones at subsequent pre-established time intervals;
comparing the detected voltages to the stored voltages in the reference array.

12. A method as in claim 11 which includes, when a detected voltage and a respective stored voltage of a zone differ by a predetermined threshold, generating a fault indicator for that zone.

13. A method as in claim 12 which includes providing a wireless transceiver, and, coupling it to the system, wherein the system can communicate with wireless devices as well as sensors of the hardwired alarm system.

14. A method as in claim 12 which includes applying one or more selected currents to a respective zone to determine a preferred operating voltage for that zone.

15. An apparatus comprising:
a monitoring system control panel which includes adjustable zone interface circuits; and
control circuits in the panel which enable the interface circuits to automatically compensate for differing end-of-line resistances whereby existing zone end-of-line resistors need not be replaced.

16. An apparatus as in claim 15 which includes a module coupled between the panel and at least one zone wherein the module includes circuitry which automatically compensates for the value of at least one end-of-line resistor of the zone.

17. An apparatus as in claim 16 where the module is in wireless communication with the control panel.
